(19) United States
(12) Patent Application Publication
(10) Pub. No.: US 2008/0063215 A1
(43) Pub. Date: Mar. 13, 2008

(54) MULTI-WINDOW PICTURE AUDIO VISUAL SYSTEM WITH TARGETED AUDIO

(75) Inventors: Gunjan Porwal, Banjara Hills (IN); Murali Krishna Kocherla, Banjara Hills (IN)

Correspondence Address: ADVANCED MICRO DEVICES, INC.;C/O VEDDER PRICE KAUFMAN & KAMMHOLZ, P.C., 222 N.LASALLE STREET, CHICAGO, IL, 60601, US

(73) Assignee: ATI Technologies ULC, Markham (CA)

(21) Appl. No.: 11/761,657

(22) Filed: Jun. 12, 2007

(30) Foreign Application Priority Data
Sep. 7, 2006 (IN) 1631/CHE/2006

(51) Int. Cl. H04B 3/00

(52) U.S. Cl. 381/77

(57) ABSTRACT

Methods and apparatus for managing audio corresponding to a video stream in an audio-visual system are disclosed. The audio-visual system includes a display capable of simultaneously displaying two or more separate video streams, and sound reproducing devices intended to deliver audio to viewers. The method includes receiving an audio-video signal comprising various channels. Two or more channels are selected for viewing. The audio associated with the selected channels are identified. The viewers who want to watch the displayed channel are identified. The sound reproducing devices associated with the intended viewers are also identified. The identified audio streams are then directed to the identified sound reproducing devices such that only the viewers associated with a given channel can hear the audio associated with that channel, to the exclusion of other viewers.

### FIELD OF THE INVENTION:

The present invention relates to a home-entertainment system which includes a display device with an ability to display multiple videos in different portions of the display screen and specifically, a method and system for directing audio streams, corresponding to different videos, to users of such systems.

### BACKGROUND OF THE INVENTION

Conventional television and other audio-video systems generate audio pertaining to a video stream e.g. in a television signal. The audio from the systems can be a cause of disturbance to people other than the viewer. Additionally, though some such systems can simultaneously display multiple videos in separate windows on the display device, at any one time, they can only generate audio corresponding to a single one of the windows.

### SUMMARY OF THE INVENTION

Methods and apparatus for managing audio corresponding to a video stream in an audio-visual system are disclosed. The audio-visual system includes sound reproducing devices intended to deliver audio to the required viewers. The method includes receiving an audio-video signal comprising various channels. Two or more channels are selected for simultaneous display by the viewers. The audio associated with each of the selected channels are identified. For each of the selected channels, the viewers who want to watch that channel are identified. The sound reproducing devices associated with those viewers are also identified. The identified audio stream for that channel is then directed to the identified sound reproducing devices such that only viewers associated with that channel can hear the audio for that channel, to the exclusion of other viewers.

### BRIEF DESCRIPTION OF THE DRAWINGS

FIG. 1 is an exemplary set-up of the inventive system.

FIG. 2 shows an exemplary inventive system for generating audio corresponding to the viewed channel.

FIG. 3 shows an exemplary inventive procedure for generating audio corresponding to the viewed television channel according to one implementation.

### DETAILED DESCRIPTION

Overview

An audio-visual system is disclosed that directs audio corresponding to a channel to certain intended viewer(s) without any other viewer(s) being able to listen to the audio.

These systems include sound-reproducing output and display devices e.g. conventional CRT TV, plasma TVs, LCD TVs etc. with the ability to display multiple videos in multiple windows. The system receives an audio-video signal through a wired or a wireless medium e.g. home-cable services, local television stations, Direct to Home (DTH), Digital Versatile Disc (DVD) player, Video Compact Disc (VCD) player, personal computer (PC) etc. The audio-video signal may include one or more channels. A plurality of viewers each selects the channels she wishes to view. The selections collectively result in the display screen being divided into smaller display regions to display the selected channels. Further, the sound reproducing devices associated with each viewer is also identified. For each selected channel, the system identifies the audio corresponding to that channel, and directs that identified audio to the sound reproducing devices associated with the viewers that selected the channel.

In one embodiment, the sound reproducing devices can be physically hardwired to an output terminal of the audio-visual system which receives audio generated by the system. The sound reproducing devices can be, for example, headphones, earphones or other similar devices.

In another embodiment, the sound reproducing devices may be one or more directional speakers. Directional speakers employing ultrasonic sound beams, like Audio Spotlight™ from Holosonic Research Labs and Hypersonic™ Sound System (HSS™) from American Technology Corporation, have been available for sometime now. Similar directional speakers and their workings are also described in U.S. Pat. No. 4,823,908 (Tanaka, et al), which is incorporated by reference herein, and which describes a manner in which the generation of audio signals takes place using directional speakers.

An Exemplary System

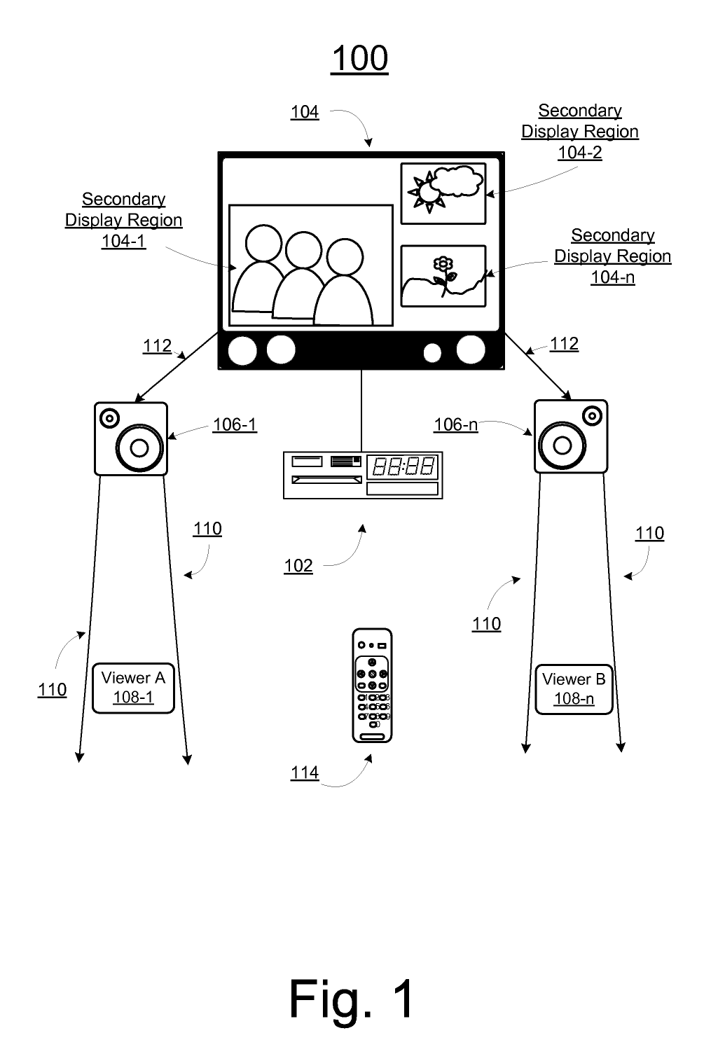

An exemplary system, describing one of the implementations, is shown in FIG. 1. A system 100 consists of an audio-visual device 102 connected to a display device 104 capable of displaying at least two video streams in separate portions of the display device 104. Specifically, each video stream can be displayed on any one of the display regions 104-1 to 104-n, as is done for picture-in-picture (PIP) television implementations. The video may originate from for example, a television channel, DTH, DVD player, VCD player, PC etc. being received by the system 100. The display device 104 is functionally connected to two or more directional speakers 106-1 to 106-n. Each directional speaker is intended to deliver the audio stream corresponding to the channel being displayed in the secondary display regions to either viewer A, 108-1 or viewer B, 108-n as depicted in FIG. 1. The system can also be extended easily by one skilled in the art so as to enable more viewers to watch the desired channel in addition to the two viewers described above. The audio generated by the directional speakers would be audible only to the viewer for whom it is intended and not to the other viewers. The emitted path lines 110 indicate the boundary of the region where the audio reproduced by the speakers 106-1 to 106-n is audible. As indicated, only the intended viewer within the emitted path lines 110 will perceive the generated audio. The display device 104 is connected to the speakers 106-1 to 106-n either through a wired or a wireless medium 112. In one implementation, the connection 112 may be realized through Digital Infrared Audio Transmission (DIAT) Technology. DIAT is a technology which can be used for transmission of digital audio throughout a local area using infrared light signals as carriers.

In one embodiment, the functionality of the audio-visual device 102 can be controlled through a user input device 114.

In one embodiment, the audio-visual device 102 may be incorporated in the circuitry of the display device 104.

In a preferred embodiment, the systems and methods for producing audio for the intended viewer(s) can be implemented by computer-executable instructions executed by a computing device. Program modules in the computing device generally include routines, programs, objects, components, data structures, etc., that perform particular tasks or implement particular abstract data types. Such systems and methods may also be implemented in hardware.

These and other aspects for producing audio for the intended viewer(s) are now described in greater detail.

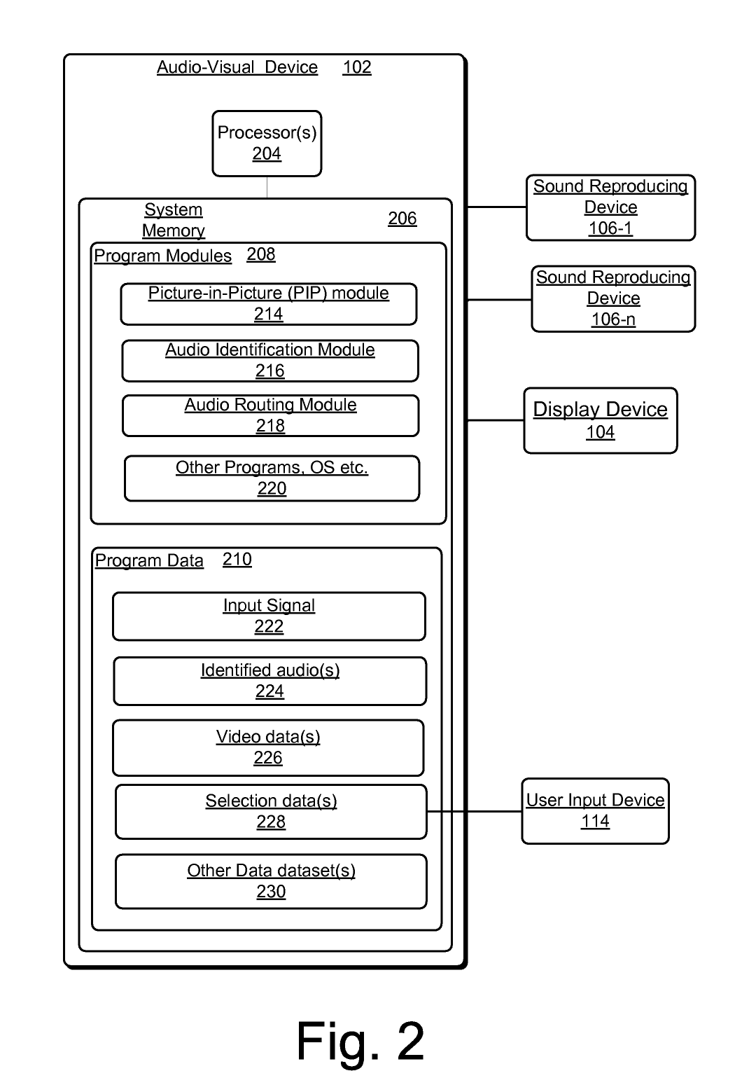

FIG. 2 shows the exemplary system 100 for producing audio corresponding to an audio-video signal, for the intended recipient. According to one embodiment, system 100 further includes an audio-visual device 102 which further comprises a processor 204, coupled to a system memory 206. The processor 204 may be a single processing entity or a plurality of processing entities such as one or more central processing units (CPUs). The system memory 206 may be a single memory device or a plurality of memory devices. The system memory 206 includes, for example volatile memory (e.g., RAM) and non-volatile memory (e.g., ROM, flash memory, etc.). The operational instructions stored in the system memory 206 are executed by the processor 204.

The system memory 206 includes program modules 208 and program data 210. The program modules 208 are responsible for causing the audio-visual device 104 to direct audio of the relevant video channel to the intended viewer through sound reproducing devices(s) 106-1 to 106-n. The sound reproducing devices can be for example, headphones/earphones, directional speakers or combinations thereof. The audio produced would thus be heard only by the intended viewer. The program data section 210 has stored data which are required and/or generated by the action of the program modules 208.

The program module 208 comprises a PIP module 214, an audio identification module 216, an audio routing module 218, and miscellaneous program module 220. The miscellaneous program module 220 includes submodules for carrying out basic system functions, and can include the operating system (OS) for the audio-visual system 102.

The program data section 210 of the system memory comprises a plurality of datasets. These include dataset(s) for storing the input signal 222, identified audio(s) 224, video data(s) 226, selection data 228 and other dataset(s) 230. The selection data 228 contains the information in relation to the user input provided by a user input device 114. The other datasets 230 store various other data generated by the program modules 208.

The PIP module 214 receives the input signal. The input signal includes one or more video streams. Operation of the PIP module 214 is initiated based on the input provided by a user input device 114. The user input device 114 e.g. a remote control, is under the control of one of the intended recipients referred to as primary viewer. On initiation through the user input device 114, the PIP module 214 divides the display area of the display device 104 into secondary display regions 104-1 to 104-n. It would be noted that the primary viewer may view one of the video streams in the an audio-video signal being displayed in the secondary display regions 104-1 to 104-n of the display device 104. The PIP module 214 displays selected video streams in the secondary display region 104-1 to 104-n based on the selection data 228 obtained through the user input device 114. The audio identification module 216 identifies the audio associated with the video streams as the identified audio(s) 224. The primary viewer, through the user input device 114, selects the sound reproducing devices 106, through which the identified audio is to be generated. The sound reproducing devices 106, in order to produce the identified audio(s) 224, have to be set-up to give the desired performance.

In one implementation, a one time set up of the sound reproducing devices can be performed by manually setting up the sound reproducing devices 106. Manual setting up of the sound reproducing devices 106 involve adjusting the direction of the speakers. In another possible implementation, the sound reproducing devices 106 might be adjusted through a separate remote controlled device.

The primary viewer allocates different selection numbers for different sound reproducing devices 106. In one implementation, the selection numbers can be allocated on the basis of selection data 228. The different selection numbers in selection data 228 are then associated with the identified audio(s) 224. The audio routing module 218 based on the association established between the identified audio(s) 224 and the sound reproducing devices 106, directs the identified audio(s) 224, to the desired sound reproducing devices 106, for sound generation. In another exemplary implementation, the association between the sound reproducing devices 106 and identified audio(s) 224 can be established either manually, automatically or a combination thereof in a manner known in the art. The sound generated can thus be heard by only the intended viewer and not by the other viewers.

In another implementation, the viewers other than the primary viewer may also be provided with secondary input devices to allow them to choose the audio/video associated with the television channels being displayed in the secondary display regions 104-1 to 104-n.

In another embodiment, the sound reproducing devices can be headphones/earphones, directional speakers or combinations thereof.

In another embodiment, the sound reproducing devices 106-1 to 106-n may be connected to the device 102 through wireless means like Digital Infrared Audio Transmission technology and other wireless technologies.

In yet another implementation, the input audio-video signal corresponds to television signals being received by the audio-visual device 102.

An Exemplary Procedure

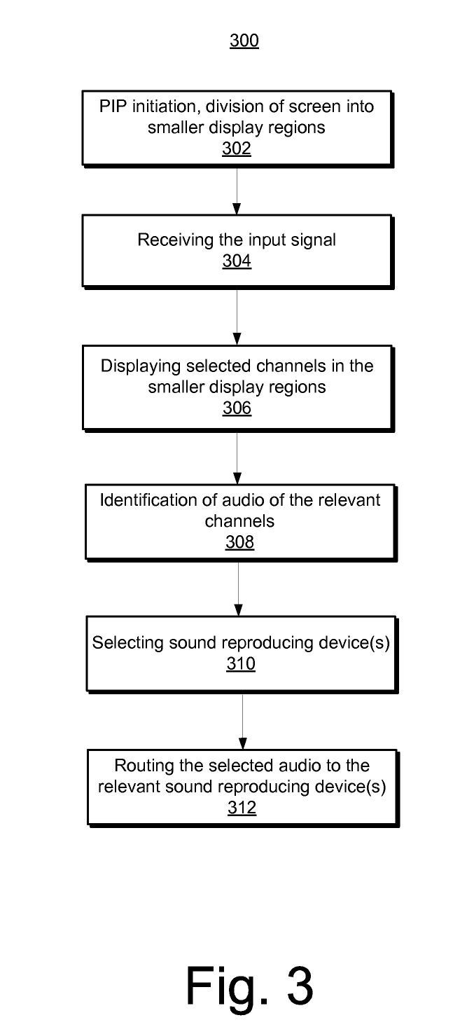

According to one implementation FIG. 3 shows an exemplary procedure 300 for generating audio corresponding to the viewed channel. For purposes of exemplary illustration and description, the operations of the procedure are described with respect to FIG. 1 and FIG. 2.

At step 302, the PIP module 214, divides the display area of the display device into secondary display regions 104-1 to 104-n based on the selection data 228 entered by the user input device 114. At step 304, the PIP module 214 receives the input signal 222. The input signal contains a plurality of television channels being received. At step 306, on the basis of the selection data 228, some channels are selected which are displayed in the secondary display regions 104-1 to 104-n of the display device 104. At step 308, the audio streams pertaining to the channels being displayed in the secondary display regions of the display device 104, are identified by the audio identification module 216. At step 310, based on selection through the user input device 114, the sound reproducing devices 106-1 to 106-n are selected for reproducing the audio

At step 312, the audio routing module 216, routes the identified audio stream corresponding to the video stream being displayed in secondary display regions of the display device 104, to the specified sound reproducing devices 106-1 to 106-n. The sound output generated by the said device will be audible only to the intended viewer(s) and will not be audible to the other viewer(s).

The above procedure for implementation has been described with respect to one embodiment of the system. It can be appreciated that the system can be implemented by other embodiments as well.

### CONCLUSION

Although the systems and methods for managing audio pertaining to a video portion of an audio-video signal, have been described in language specific to structural features and/or operations or actions, it is understood that the implementations defined in the appended claims are not necessarily limited to the specific features or actions described. Rather, the specific features and operations of this invention are disclosed as exemplary embodiments and are not intended to limit the scope of the subject matter disclosed herein.

I/We claim:

1. A method for directing an audio stream corresponding to an audio-video signal, within an audio-visual system, said system comprising sound reproducing device and a display device capable of displaying multiple audio-video signals, the method comprising:
a. receiving an input signal comprising a plurality of audio-video signals;
b. selecting a subset of the plurality of audio-video signals for viewing on the display device;
c. associating each selected audio-video signal with a selecting viewer;
d. identifying an audio stream corresponding to each selected audio-video signal;
e. identifying the sound reproducing device associated with the selecting viewer; and
f. directing the identified audio streams to the identified sound reproducing device such that the selecting viewer hears the identified audio stream to the exclusion of other viewers that have not selected the same audio-video signal.

2. The method of claim 1, wherein the sound reproducing device is selected from a group comprising a head phone, an ear phone or other portable audio devices.

3. The method of claim 1, wherein the sound reproducing device is a directional audio speaker.

4. The method of claim 1, wherein the display device possesses picture-in-picture capability.

5. The method of claim 1, wherein the input signal is received through a wired or a wireless medium.

6. The method of claim 1, wherein the sound reproducing devices are selected through a user interface.

7. A system for managing audio stream corresponding to audio-video signals on a display device capable of displaying multiple audio-video signals, the system comprising a plurality of sound reproducing devices, a processor coupled to a memory, said memory having computer instructions for:
a. receiving an input signal comprising a plurality of audio-video signals;
b. selecting a subset of the plurality of audio-video signals for viewing on the display device;
c. associating each selected audio-video signal with a selecting viewer;
d. identifying an audio stream corresponding to each selected audio-video signal;
e. identifying the sound reproducing device associated with the selecting viewer; and
f. directing the identified audio streams to the identified sound reproducing device such that the selecting viewer hears the identified audio stream to the exclusion of other viewers that have not selected the same audio-video signal.

8. The system of claim 7, wherein the sound reproducing device is a directional audio speaker.

9. The system of claim 7, wherein the sound reproducing device is selected from a group comprising of a head phone, an ear phone or other portable devices.

10. The system of claim 7, wherein the display device possesses Picture-in-Picture capability.

11. The system of claim 7, wherein the input signal is received through a wired or a wireless medium.

12. The system of claim 7, wherein the sound reproducing devices are selected through user interface.

13. A computable readable medium for an audio-visual system comprising sound reproducing devices, display device capable of displaying video in multiple windows, the medium comprising instructions, which when executed, directs the audio-visual system to:
a. receiving an input signal comprising a plurality of audio-video signals;
b. selecting a subset of the plurality of audio-video signals for viewing on the display device;
c. associating each selected audio-video signal with a selecting viewer;
d. identifying an audio stream corresponding to each selected audio-video signal;
e. identifying the sound reproducing device associated with the selecting viewer; and
f. directing the identified audio streams to the identified sound reproducing device such that the selecting viewer hears the identified audio stream to the exclusion of other viewers that have not selected the same audio-video signal.

14. The medium of claim 13, wherein the sound reproducing device is a directional audio speaker.

15. The medium of claim 13, wherein the sound reproducing device is selected from a group comprising of a head phone, an ear phone or other portable devices.

16. The medium of claim 13, wherein the display device possesses Picture-in-Picture capability.

17. The medium of claim 13, wherein the input signal is received through a wired or a wireless medium.

18. The medium of claim 13, wherein the sound reproducing devices are selected through user interface.
